(19) United States
(12) Patent Application Publication
(10) Pub. No.: US 2023/0082957 A1
(43) Pub. Date: Mar. 16, 2023

(54) HERBICIDAL COMPOSITIONS COMPRISING FLUAZIFOP, TRICLOPYR AND DIQUAT

(71) Applicant: BAYER CROPSCIENCE LP, Saint Louis, MO (US)

(72) Inventors: Jeffrey HUGHES, Saint Louis, MO (US); Paul RATLIFF, Olivette, MO (US); Daniel WRIGHT, Saint Louis, MO (US)

(21) Appl. No.: 17/903,255

(22) Filed: Sep. 6, 2022

Related U.S. Application Data
(60) Provisional application No. 63/241,790, filed on Sep. 8, 2021.

(51) Int. Cl. A01N 43/40; A01N 43/90; A01N 43/54; A01P 13/00; A01N 25/04

(52) U.S. Cl. CPC A01N 43/40; A01N 43/90; A01N 43/54; A01P 13/00; A01N 25/04

(57) ABSTRACT

The present invention primarily relates to certain herbicidal compositions based on the herbicidal active ingredients (A) fluazifop or an ester thereof, (B) triclopyr or an ester or salt thereof and (C) a diquat dihalide salt, optionally additionally comprising (D) imazapic or a salt thereof. The invention also relates to the field of plant protection and environmental health, and to methods and uses of the herbicidal compositions of the present invention for controlling unwanted plant growth.

### CROSS-REFERENCE TO RELATED APPLICATIONS

This application claims the benefit of and priority to U.S. Provisional Application Ser. No. 63/241,790, filed Sep. 8, 2021, the entire disclosure of which is hereby incorporated by reference

### FIELD OF THE INVENTION

The present invention primarily relates to certain herbicidal compositions based on the herbicidal active ingredients (A) fluazifop or an ester thereof, (B) triclopyr or an ester or salt thereof and (C) a diquat dihalide salt, optionally additionally comprising (D) imazapic or a salt thereof. The invention also relates to the field of plant protection and environmental health, and to methods and uses of the herbicidal compositions of the present invention for controlling unwanted plant growth.

### BACKGROUND OF THE INVENTION

The field of plant protection and environmental health amongst other aspects relates to controlling unwanted plants (weed plants, weeds) in urban or home environments like driveways, patios, sidewalks, paths, gravel areas, around trees and along fences.

Controlling unwanted plants (weed control) is generally desired in the field of environmental health, not only for aesthetic purposes, for example in landscape or hardscape areas, areas for parks, public or private gardens, sports grounds or arenas, flower gardens, mulch beds, ornamental gardens, around trees (e.g. plantations and orchards). In the management for instance in a garden, in public areas, roadsides, homes etc., control of weeds is the most important task for keeping views and good maintenance of the sites.

Up to now, however, typical satisfactory herbicide products for such weed control are based on glyphosate or dicamba.

Some commercial products like Roundup® products are based on the herbicidal active ingredient glyphosate in combination with other herbicidal active ingredients like pelargonic acid or in combination with imazapic ammonium and diquat dibromide (in case of the Roundup® 365-series). Other commercial products contain as herbicidal active ingredients ammonium nonanoate (e.g. Ortho™ Groundclear) or a combination of fluazifop-P-butyl, dicamba dimethyl ammonium, and diquat dibromide (e.g. Spectracide™ Weed&Grass Killer, Ortho™ Groundclear Weed&Grass Killer Super Concentrate).

Several publications disclose herbicidal combinations involving the above-mentioned herbicidal active ingredients (herbicides), often in combination with other herbicides. For example, WO 2004/093546 discloses herbicidal compositions comprising glyphosate and a pyridine analog, such as triclopyr, and WO 2006/033988 discloses compositions comprising glyphosate and fatty acid components like pelargonic acid, optionally comprising further herbicides, inter alia imazapic.

Other publications like WO 2010/009819 or WO 2010/127796 suggest the use of compositions based on certain compounds, optionally in combination with other herbicides, for the selective weed (unwanted plant growth) control in turfgrass areas.

One objective of the present invention is to provide further herbicidal compositions which permit effective control of unwanted plants (weeds), and which particular permit effective control of unwanted plants (weeds) in the field of plant protection and environmental health, in particular without the necessity to use or presence of glyphosate (N-(phosphonomethyl)glycine), dicamba (3,6-dichloro-2-methoxybenzoic acid) or 2,4-D (2,4-dichlorophenoxy)acetic acid), or salts or esters thereof in said herbicidal compositions.

### BRIEF DESCRIPTION OF THE INVENTION

The above objectives have been achieved with herbicidal compositions, wherein the herbicidal active ingredients comprise or consist of
(A) fluazifop or an ester thereof,
(B) triclopyr or an ester or an agriculturally acceptable salt thereof, and
(C) a diquat dihalide salt,
wherein the ratio by weight of the total amount of component (A) to the total amount of component (B) is in the range of from about 2:1 to about 1:4, typically in the range of from about 2:1 to about 1:3,
and/or
wherein the ratio by weight of the total amount of component (A) to the total amount of component (C) is in the range of from about 2:1 to about 1:3, more typically in the range of from about 2:1 to about 1:2.

The above objects have also been achieved with herbicidal compositions, additionally comprising (D) imazapic or an agriculturally acceptable salt thereof.

The herbicidal compositions of the present invention can be in the form of concentrates, i.e. concentrated formulations which typically is diluted with an appropriate amount of water before application, or in the ready-to-use (RTU) forms, typically a spray application mixture.

In further aspects, the present invention relates to methods for controlling weed plants using the compositions of the present invention in the form of a ready-to-use spray application mixture.

### DETAILED DESCRIPTION OF THE INVENTION

It has now been found that certain compositions comprising the herbicidal active ingredients fluazifop or an ester thereof (component (A)), triclopyr or an ester or an agriculturally acceptable salt thereof (component (B)), and a diquat dihalide salt (component (C)), optionally additionally comprising imazapic or an agriculturally acceptable salt thereof (component (D)), have the desired properties and provide the desired weed killing effects, early visual symptomology, i.e. early herbicidal or phytotoxic activity after application of the compositions, and optionally exhibit prolonged and residual weed control effects.

Thus, in certain preferred embodiments, the herbicidal active ingredients of the herbicidal composition according to the present invention comprise or consist of
(A) fluazifop or an ester thereof,
(B) triclopyr or an ester or an agriculturally acceptable salt thereof,
(C) a diquat dihalide salt,
and
(D) imazapic or an agriculturally acceptable salt thereof,
wherein the ratio by weight of the total amount of component (A) to the total amount of component (B) is in the range of from about 2:1 to about 1:4, typically in the range of from about 2:1 to about 1:3,
and/or
wherein the ratio by weight of the total amount of component (A) to the total amount of component (C) is in the range of from about 2:1 to about 1:3, typically in the range of from about 2:1 to about 1:2.

The active ingredient fluazifop (CAS Reg. No. 69335-91-7; IUPAC name: 2-[4-[[5-(trifluoromethyl)-2-pyridyl]oxy]phenoxy]propanoic acid) is a herbicidal ingredient (herbicide) known from WO 79/00094, the (+)-enantiomer of this substance has the common name fluazifop-P (CAS Reg. No. 83066-88-0). Fluazifop is an acetyl CoA carboxylase (ACCase) inhibitor. An important ester of fluazifop is fluazifop-butyl (CAS Reg. No. 69806-50-4), the (R)-enantiomer thereof is fluazifop-P-butyl (CAS Reg. No. 79241-46-6; IUPAC name: butyl (2R)-2-(4-{[5-(trifluoromethyl)pyridin-2-yl]oxy}phenoxy)propanoate)) . Fluazifop and fluazifop-P-butyl are herbicides effective against grasses (monocotyledonous weeds).

The active ingredient triclopyr (CAS Reg. No. 55335-06-3; IUPAC name: [(3,5,6-trichloro-2-pyridyl)oxy]acetic acid) is a herbicidal ingredient (herbicide) known from U.S. Pat. No. 3,862,952. It is used in the agrochemical industry often as salt or ester, for example as triclopyr-triethylammonium (CAS Reg. No. 57213-69-1; IUPAC name: [(3,5,6-trichloro-2-pyridyl)oxy]acetic acid-triethylamine (1:1). Triclopyr is a synthetic auxin. Triclopyr is a systemic herbicide effective against broad-leaved (dicotyledonous) weeds.

The active ingredient diquat (CAS Reg. No. 2764-72-9; IUPAC name: 6,7-dihydrodipyrido[1,2-a:2′,1′-c]pyrazine-5,8-diium) is a herbicidal ingredient (herbicide) known from U.S. Pat. No. 2,823,987. It is used in the agrochemical industry often as salt, for example as diquat dibromide (CAS Reg. No. 85-00-7; IUPAC name: 6,7-dihydrodipyrido[1,2-a:2′,1′-c]pyrazine-5,8-diium dibromide). Diquat is an inhibitor of the Photosystem I. Diquat is used for non-selective weed control having no residual activity. In the context of the present invention, diquat is used as co-herbicide providing early symptomology, i.e. early herbicidal or phytotoxic activity, against the undesired or unwanted plants (weeds).

The active ingredient imazapic (CAS Reg. No.104098-48-8; IUPAC name: 2-[(4RS)-4-isopropyl-4-methyl-5-oxo-2-imidazolin-2-yl]-5-methylpyridine-3-carboxylic acid) is a herbicidal ingredient (herbicide) known from EP 0 041 624. It is used in the agrochemical industry often as salt, for example as imazapic-ammonium (CAS Reg. No. 115136-53-3; IUPAC name: ammonium 2-[(RS)-4-isopropyl-4-methyl-5-oxo-2-imidazolin-2-yl]-5-methylnicotinate). Imazapic is an acetolactate synthase (ALS) inhibitor. Imazapic is a broad-spectrum herbicide. If present in the compositions of the present invention, imazapic is used in the context of the present invention to provide residual weed control activity of the compositions of the present invention. Said residual weed control activity typically lasts for about 4 to 12 months after application of a composition of the present invention.

In summary, in herbicidal compositions according to the present invention components (A) and (B) in combination largely account for the activity against grasses (component (A)) and broad-leaved (dicotyledonous) weeds (component (B)), component (C) provides for early symptomology, i.e. establishing fast and early phytotoxic or herbicidal activity, and if present, component (D) provides soil residual (i.e. long lasting) weed control activity. The compositions according to the present invention thus provide the combination of herbicidal activity against a broad weed spectrum with a fast onset of herbicidal symptomology (and a long-lasting soil herbicidal activity, if component (D) is present).

In certain other preferred embodiments, in the herbicidal composition according to the present invention Component (A) comprises or consists of a fluazifop alkyl ester, typically fluazifop-P-butyl, and/or Component (B) comprises or consists of a triclopyr ammonium salt, typically triclopyr-triethylammonium.

In still other preferred embodiments, in the herbicidal composition according to the present invention Component (A) comprises or consists of fluazifop-P-butyl, Component (B) comprises or consists of triclopyr-triethylammonium, and Component (C) comprises or consists of diquat dibromide.

In various preferred embodiments, in the herbicidal composition according to the present invention Component (D) comprises or consists of imazapic-ammonium.

The weight ratios of components (A), (B) and (C), and optionally (D), can be varied within the ranges indicated herein. However, within certain concentration ranges or ratio by weight ranges, the herbicidal effects of the herbicidal compositions of the invention is particularly pronounced and/or the herbicidal activity and efficacy particularly high.

In certain preferred herbicidal compositions according to the present invention the ratio by weight of the total amount of component (A) to the total amount of component (B) is in the range of from about 2:1 to about 1:3, typically from about 3:2 to about 2:5, more typically from about 1:1 to about 1:2, in each case based on the total weight of the composition. In some embodiments, the ratio by weight of the total amount of component (A) to the total amount of component (B) is about 4:5, based on the total weight of the composition.

In other preferred herbicidal compositions according to the present invention the ratio by weight of the total amount of component (A) to the total amount of component (C) is in the range of from about 2:1 to about 1:2, typically from about 3:2 to about 2:3, in each case based on the total weight of the composition. In some embodiments, the ratio by weight of the total amount of component (A) to the total amount of component (C) is about 4:3, based on the total weight of the composition.

If a herbicidal composition according to the present invention comprises component (D), the ratio by weight of the total amount of component (A) to the total amount of component (D) typically is in the range of from about 10:1 to about 1:2, typically from about 8:1 to about 2:3, in each case based on the total weight of the composition. In some embodiments, the ratio by weight of the total amount of component (A) to the total amount of component (D) is about 5:4 or about 20:3, in each case based on the total weight of the composition.

In certain preferred embodiments, in a herbicidal composition according to the present invention the ratio by weight of the total amount of component (A) to the total amount of component (B) is in the range of from about 2:1 to about 1:3 and the ratio by weight of the total amount of component (A) to the total amount of component (C) is in the range of from about 2:1 to about 1:2, and if present, the ratio by weight of the total amount of component (A) to the total amount of component (D) typically is in the range of from about 10:1 to about 1:2, in each case based on the total weight of the composition.

In certain other preferred embodiments, in a herbicidal composition according to the present invention the ratio by weight of the total amount of component (A) to the total amount of component (B) is in the range of from about 3:2 to about 2:5 and the ratio by weight of the total amount of component (A) to the total amount of component (C) is in the range of from about 2:1 to about 1:2, and if present, the ratio by weight of the total amount of component (A) to the total amount of component (D) typically is in the range of from about 10:1 to about 1:2, in each case based on the total weight of the composition.

In still other preferred embodiments, in a herbicidal composition according to the present invention the ratio by weight of the total amount of component (A) to the total amount of component (B) is in the range of from about 1:1 to about 1:2 and the ratio by weight of the total amount of component (A) to the total amount of component (C) is in the range of from about 3:2 to about 2:3, and if present, the ratio by weight of the total amount of component (A) to the total amount of component (D) typically is in the range of from about 8:1 to about 2:3, in each case based on the total weight of the composition.

In some embodiments, in a herbicidal composition according to the present invention the ratio by weight of the total amount of component (A) to the total amount of component (B) is about 4:5 and the ratio by weight of the total amount of component (A) to the total amount of component (C) is about 4:3, and if present, the ratio by weight of the total amount of component (A) to the total amount of component (D) is about 5:4 or about 20:3, in each case based on the total weight of the composition.

The herbicidal composition according to the present invention generally is a composition (i.e. a mixture), typically in the form of a concentrated formulation (concentrate) or a ready-to-use (RTU) diluted spray application mixture.

The herbicidal composition according to the present invention typically comprise the components (A), (B) and (C) in the composition in the following amounts:
Component (A) in an amount in the range of from about 0.04 wt. % to about 3.5 wt. %,
Component (B) in an amount in the range of from about 0.05 wt. % to about 4.0 wt. %,
Component (C) in an amount in the range of from about 0.04 wt. % to about 3.0 wt. %,
in each case based on the total weight of the composition.

The herbicidal composition according to the present invention typically comprises the components (A), (B) and (C) in the composition in the following amounts:
Component (A) in an amount in the range of from about 0.05 wt. % to about 3.0 wt. %,
Component (B) in an amount in the range of from about 0.07 wt. % to about 3.5 wt. %,
Component (C) in an amount in the range of from about 0.05 wt. % to about 2.5 wt. %,
in each case based on the total weight of the composition.

If the herbicidal compositions according to the present invention are concentrate compositions (concentrates), the components (A), (B) and (C) in the composition typically are present in the following amounts:
Component (A) in an amount in the range of from about 1.0 wt. % to about 2.5 wt. %, typically about 2.0 wt. %,
Component (B) in an amount in the range of from about 2.0 wt. % to about 3.0 wt. %, typically about 2.5 wt. %,
Component (C) in an amount in the range of from about 1.0 wt. % to about 2.0 wt. %, typically about 1.5 wt. %,
in each case based on the total weight of the composition.

If the herbicidal compositions according to the present invention are ready-to-use (RTU) compositions, the components (A), (B) and (C) in the composition typically are present in the following amounts:
Component (A) in an amount in the range of from about 0.04 wt. % to about 0.15 wt. %, in certain preferred embodiments about 0.1 wt. %,
Component (B) in an amount in the range of from about 0.075 wt. % to about 0.175 wt. %, in certain preferred embodiments about 0.122 wt. % or about 0.125 wt. %, and/or
Component (C) in an amount in the range of from about 0.05 wt. % to about 0.10 wt. %, in certain preferred embodiments about 0.072 wt. % or about 0.075 wt. %,
in each case based on the total weight of the composition.

The herbicidal composition according to the present invention may comprise component (D), and if present, the amount of component (D) typically is in the range of from about 0.0075 wt. % to about 2.5 wt. %, more typically in an amount in the range of from about 0.01 wt. % to about 2.0 wt. %, in each case based on the total weight of the composition.

If the herbicidal compositions according to the present invention are concentrate compositions (concentrates) and comprise (D), the amount of component (D) typically is in the range of from about 0.2 wt. % to about 2.0 wt. %, typically about 0.3 wt. % or about 1.6 wt. %, in each case based on the total weight of the composition.

If the herbicidal compositions according to the present invention are ready-to-use (RTU) compositions and comprise (D), the amount of component (D) typically is in the range of from about 0.01 wt. % to about 0.15 wt. %, in certain preferred embodiments about 0.015 wt. %, or about 0.078 wt. %, or about 0.08 wt. %, or about 0.17 wt. %, in each case based on the total weight of the composition.

In some embodiments the herbicidal compositions according to the present invention are concentrate compositions (concentrates) comprising
Component (A) in an amount in the range of from about 1.9 wt. % to about 2.1 wt. %,
Component (B) in an amount in the range of from about 2.4 wt. % to about 2.6 wt. %, and
Component (C) in an amount in the range of from about 1.3 wt. % to about 1.7 wt. %,
in each case based on the total weight of the composition.

In some embodiments the herbicidal compositions according to the present invention are concentrate compositions (concentrates) comprising
Component (A) in an amount in the range of from about 1.9 wt. % to about 2.1 wt. %,
Component (B) in an amount in the range of from about 2.4 wt. % to about 2.6 wt. %,
Component (C) in an amount in the range of from about 1.3 wt. % to about 1.7 wt. %, and
Component (D) in an amount in the range of from about 0.24 wt. % to about 0.36 wt. %,
in each case based on the total weight of the composition.

In some embodiments the herbicidal compositions according to the present invention are concentrate compositions (concentrates) comprising
Component (A) in an amount in the range of from about 1.9 wt. % to about 2.1 wt. %,
Component (B) in an amount in the range of from about 2.4 wt. % to about 2.6 wt. %,
Component (C) in an amount in the range of from about 1.3 wt. % to about 1.7 wt. %, and
Component (D) in an amount in the range of from about 1.4 wt. % to about 1.8 wt. %,
in each case based on the total weight of the composition.

In some embodiments the herbicidal compositions according to the present invention are ready-to-use (RTU) compositions comprising
Component (A) in an amount in the range of from about 0.078 wt. % to about 0.116 wt. %,
Component (B) in an amount in the range of from about 0.098 wt. % to about 0.146 wt. %, and
Component (C) in an amount in the range of from about 0.058 wt. % to about 0.088 wt. %,
in each case based on the total weight of the composition.

In some embodiments the herbicidal compositions according to the present invention are ready-to-use (RTU) compositions comprising
Component (A) in an amount in the range of from about 0.078 wt. % to about 0.116 wt. %,
Component (B) in an amount in the range of from about 0.098 wt. % to about 0.146 wt. %,
Component (C) in an amount in the range of from about 0.058 wt. % to about 0.088 wt. %, and
Component (D) in an amount in the range of from about 0.012 wt. % to about 0.018 wt. %,
in each case based on the total weight of the composition.

In some embodiments the herbicidal compositions according to the present invention are ready-to-use (RTU) compositions comprising
Component (A) in an amount in the range of from about 0.078 wt. % to about 0.116 wt. %,
Component (B) in an amount in the range of from about 0.098 wt. % to about 0.146 wt. %,
Component (C) in an amount in the range of from about 0.058 wt. % to about 0.088 wt. %, and
Component (D) in an amount in the range of from about 0.062 wt. % to about 0.094 wt. %,
in each case based on the total weight of the composition.

The herbicidal compositions according to the present invention may comprise or else be used together with additional, further components, examples being active crop protection ingredients of other kinds and/or adjuvants customary in the art of agrochemical formulation and/or formulating assistants.

Thus, the herbicidal compositions according to the present invention typically additionally comprise one or more further constituents selected from the group consisting of water and formulation adjuvants (formulation auxiliaries).

The herbicidal compositions according to the present invention generally have a water content in an amount in the range of from about 60 wt. % to about 99.5 wt. %, typically in an amount in the range of from about 70 wt. % to about 99.5 wt. %, in each case based on the total weight of the composition.

If the herbicidal compositions according to the present invention are concentrate compositions (concentrates), the amount of water typically is in the range of from about 60 wt. % to about 85 wt. %, typically in the range of from about 65 wt. % to about 80 wt. %, more typically in the range of from about 70 wt. % to about 77 wt. %, in each case based on the total weight of the composition.

If the herbicidal compositions according to the present invention are ready-to-use (RTU) compositions, the amount of water typically is in the range of from about 90 wt. % to about 99.5 wt. %, typically in the range of from about 95 wt. % to about 99.5 wt. %, more typically in the range of from about 97 wt. % to about 99.5 wt. %, in each case based on the total weight of the composition.

Typically, the herbicidal compositions according to the present invention comprise water and one or more further constituents selected from the group consisting of formulation adjuvants.

In certain preferred embodiments, the herbicidal compositions according to the present invention comprise water and one or more further constituents selected from the group consisting of formulation adjuvants selected from the group consisting of surfactants, emulsifiers, dispersants, organic solvents, anti-freeze agents, pH-regulation agents, biocides and antifoam agents.

In certain preferred embodiments, the herbicidal compositions according to the present invention comprise water and two, three, four or more further constituents selected from the group consisting of formulation adjuvants selected from the group consisting of surfactants, emulsifiers, organic solvents, pH-regulation agents, biocides and antifoam agents.

The herbicidal compositions according to the present invention may comprise one or more surfactants and/or emulsifiers. Useful surfactants and/or emulsifiers include: for example non-ionic and anionic emulsifiers, such as polyoxyethylene fatty acid esters, polyoxyethylene fatty alcohol ethers, e.g. alkylaryl polyglycol ethers, alkylsulphonates, alkyl sulphates, arylsulphonates and protein hydrolysates.

The herbicidal compositions according to the present invention typically comprise one or more non-ionic surfactants, typically selected from the group consisting of polyethoxylated (POE) fatty acid esters, polyethoxylated (POE) fatty alcohols, polyalkylene oxide block copolymers, and mixtures thereof.

In certain preferred embodiments, the herbicidal compositions according to the present invention comprise one or more non-ionic surfactants selected from the group consisting of polyethoxylated castor oils, typically with a degree of ethoxylation in the range of from about 10 to about 40 (i.e. from about POE 10 to about POE 40), typically with POE 25 or POE 30, for example available as Agnique® CSO-25 or Agnique® CSO-30 from Cognis), C₈-C₁₈ alkyl alcohol polyethoxylates, typically isodecyl alcohol ethoxylate POE 6 (for example available as Makon® DA-6 from Stepan), butyl polyalkylene oxide block copolymer (for example available as Toximul® 8320 from Stepan), and mixtures thereof.

The herbicidal compositions according to the present invention typically comprise one or more surfactants, typically one or more non-ionic surfactants, in an amount in the range of from about 0.15 wt. % to about 25 wt. %, typically in an amount in the range of from about 0.25 wt. % to about 20 wt. %, more typically in an amount in the range of from about 0.3 wt. % to about 12 wt. %, in each case based on the total weight of the composition.

If the herbicidal compositions according to the present invention are concentrate compositions (concentrates), the amount of surfactants, typically of non-ionic surfactants, typically is in the range of from about 5 wt. % to about 25 wt. %, typically in the range of from about 7 wt. % to about 20 wt. %, more typically in the range of from about 8 wt. % to about 15 wt. %, in each case based on the total weight of the composition.

If the herbicidal compositions according to the present invention are ready-to-use (RTU) compositions, the amount of surfactants, typically of non-ionic surfactants, typically is in the range of from about 0.15 wt. % to about 2.0 wt. %, typically in the range of from about 0.25 wt. % to about 1.5 wt. %, more typically in the range of from about 0.3 wt. % to about 1.0 wt. %, in each case based on the total weight of the composition.

The herbicidal compositions according to the present invention may comprise one or more organic solvents. Useful organic solvents are liquid at 25° C. and 1013 mbar, and may be selected from aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example petroleum fractions, mineral oils and vegetable oils, alcohols, such as butanol or alkylene glycols, such as propylene glycol, dipropylene glycol, and the ethers and esters of alcohols or alkylene glycols, ketones, such as acetone, methyl ethyl ketone, methyl isobutyl ketone or cyclohexanone, and strongly polar solvents, such as dimethylformamide or dimethyl sulphoxide.

In certain preferred embodiments, the herbicidal compositions according to the present invention comprise one or more organic solvents selected from the group consisting of propylene glycol, dipropylene glycol, and mixtures thereof.

If the herbicidal compositions according to the present invention are concentrate compositions (concentrates) and comprise alkylene glycols, in particular propylene glycol, the amount of alkylene glycols, in particular propylene glycol, typically is in the range of from about 5 wt. % to about 15 wt. %, more typically in the range of from about 8 wt. % to about 12 wt. %, in each case based on the total weight of the composition.

In some embodiments, the herbicidal compositions according to the present invention comprise one or more polyethylene glycols, typically polyethylene glycol 400 (PEG 400), as organic co-solvent.

If present, the amount of polyethylene glycols, in particular of polyethylene glycol 400, in the herbicidal compositions of the present invention typically is in the range of from about 0.1 wt. % to about 8 wt. %, more typically in the range of from about 0.2 wt. % to about 6 wt. %, in each case based on the total weight of the composition.

If the herbicidal compositions according to the present invention are concentrate compositions (concentrates) and comprise polyethylene glycols, in particular polyethylene glycol 400, the amount of polyethylene glycols, in particular of polyethylene glycol 400, typically is in the range of from about 3.0 wt. % to about 7.0 wt. %, more typically in the range of from about 4.0 wt. % to about 6.0 wt. %, in each case based on the total weight of the composition.

If the herbicidal compositions according to the present invention are ready-to-use (RTU) compositions, and comprise polyethylene glycols, in particular polyethylene glycol 400, the amount of polyethylene glycols, in particular of polyethylene glycol 400, typically is in the range of from about 0.1 wt. % to about 0.5 wt. %, more typically in the range of from about 0.15 wt. % to about 0.4 wt. %, in each case based on the total weight of the composition.

The herbicidal compositions according to the present invention typically have a pH-value in the range of from about 4.5 to about 7.5, typically in the range of from about 5 to about 7.5, more typically in the range of from about 5.2 to about 7.2.

The pH-value of a herbicidal composition according to the present invention was measured using conventional pH measuring equipment, typically by immersing the probe of a pH meter into a sample of the composition. Prior to measuring pH of the composition, the pH meter was calibrated in accordance with the manufacturer's recommended protocol.

The herbicidal compositions according to the present invention may comprise one or more pH-regulation agents, typically one or more acids, in turn typically one or more organic acids, in certain preferred embodiments citric acid.

If present in the herbicidal compositions according to the present invention, the pH-regulation agents are present in an amount needed to achieve the pH-value of the compositions as indicated above. Typically, an amount of citric acid is used in the range of from about 0.005 wt. % to about 0.15 wt. %, more typically in the range of from about 0.01 wt. % to about 0.1 wt. %, in each case based on the total weight of the composition.

The herbicidal compositions according to the present invention may comprise one or more antifoam agents, typically one or more silicone-based antifoam agents, in turn typically silicone-based antifoam emulsions and polydimethylsiloxane-based antifoam emulsions, for example the commercially available antifoam agents SAG 10 or SAG 1572 available from Momentive Performance Materials.

The herbicidal compositions according to the present invention may comprise one or more biocides. A biocide is a substance used for the control of organisms that are harmful and would cause damage to the compositions of the present invention, i.e. used for the preservation of the compositions of the present invention. A preferred biocide in the context of the present invention is an antimicrobial, typically 1,2-benzisothiazolin-3-one, as for example commercially available from Lonza, e.g. as Proxel® GXL (a 20 wt. % solution of 1,2-benzisothiazolin-3-one in aqueous dipropylene glycol.

The herbicidal compositions according to the present invention may comprise one or more dispersants. Useful dispersants include: for example lignosulphite waste liquors and methylcellulose.

The herbicidal compositions according to the present invention may comprise one or more solid carriers. Useful solid carriers include: for example ammonium salts and ground natural minerals, such as kaolins, clays, talc, chalk, quartz, attapulgite, montmorillonite or diatomaceous earth, and ground synthetic minerals, such as finely divided silica, alumina and silicates; other useful solid carriers include for example crushed and fractionated natural rocks, such as calcite, marble, pumice, sepiolite, dolomite or organic solid carrier materials, such as sawdust, coconut shells, maize cobs and tobacco stalks.

The herbicidal compositions according to the present invention may comprise one or more tackifiers. It is possible to use tackifiers such as carboxymethylcellulose, natural and synthetic polymers in the form of powders, granules or latices, such as gum arabic, polyvinyl alcohol and polyvinyl acetate, or else natural phospholipids such as cephalins and lecithins and synthetic phospholipids.

The herbicidal compositions according to the present invention may comprise one or more colorants. It is possible to use colorants such as inorganic pigments, for example iron oxide, titanium oxide and Prussian Blue, and organic dyes, such as alizarin dyes, azo dyes and metal phthalocyanine dyes.

The compositions of the present invention typically are aqueous herbicidal liquid compositions at 25° C. and 1013 mbar.

Depending inter alia on the requirements of the unwanted (weed) plants present or expected in the area to be treated, it may be desired or necessary to further complement and optimize the weed control spectrum of the compositions of the present invention, the herbicidal compositions according to the present invention may be combined with one or more further herbicides. Thus, the herbicidal compositions according to the present invention may additionally comprises one or more further herbicides.

Typically, the herbicidal composition according to the present invention do not contain, i.e. are free of, glyphosate, esters and salts thereof, and free of dicamba, esters and salts thereof.

Typically, the herbicidal composition according to the present invention do not contain, i.e. are free of, 2,4-D, esters and salts thereof.

However, in certain preferred embodiments the herbicidal composition according to the present invention the components (A), (B), (C), and optionally (D), are the only herbicidal active ingredients present in the composition.

Certain preferred herbicidal compositions of the present invention are those containing component (A), component (B), and component (C), optionally component (D) as only active agrochemical ingredients.

Further herbicides optionally incorporated into or mixed with the herbicidal compositions of the present invention and the common names used herein are known in the art; see, for example, “The Pesticide Manual” 16^{th} Edition, British Crop Protection Council 2012; these include the known stereoisomers (in particular racemic and enantiomeric pure isomers) and derivatives such as salts or esters, and particularly the commercially customary forms. Where a herbicide is referenced generically herein by name, unless otherwise restricted, that herbicide includes all commercially available forms known in the art such as salts, esters, free acids and free bases, as well as stereoisomers thereof.

The term “locus” of a weed plant(s) (i.e. the unwanted plant(s)) comprises the weed plant(s), part of the weed plants, seed of the weed plants or the area where the weed plants are growing or will be growing. Thus, the term “locus” includes the (natural) soil, which is typically present on a land area, including soil that has been modified, such as soil that has been granulated and/or treated with agrochemicals, such as for example fertilizers.

The compositions of the present invention are used for controlling undesired plants, i.e. for weed control. This activity allows to apply the compositions of the present invention as effective herbicidal active products pre- and post-emergence, related to the emergence of the weeds, for controlling broad-leaved (dicotyledonous) weeds and grass (monocotyledonous) weeds as herbicide.

The compositions of the present invention are non-selective weed control compositions and for example can be used as burndown herbicide compositions for so-called burndown weed control.

In certain preferred embodiments, the compositions of the present invention are applied pre-emergence related to the emergence of the unwanted plant (weed).

In other preferred embodiments, the compositions of the present invention are applied post-emergence related to the emergence of the unwanted plant (weed).

The herbicidal compositions based on the herbicidal active ingredients (A), (B) and (C) as defined in the context of the present invention mainly have post-emergence activity and therefore typically are applied early post-emergence or post-emergence related to the emergence of the unwanted plants (weeds).

The herbicidal compositions based on the herbicidal active ingredients (A), (B), (C) and (D) as defined in the context of the present invention have both pre-emergence and post-emergence activity and are therefore typically are applied pre-emergence, early post-emergence or post-emergence to the emergence of the unwanted plants (weeds), ie these compositions can be applied to the entire area intended to remain weed-free with or without post-emergent weeds being present.

The compositions typically are applied to the (locus of the) weed plants as a sprayable liquid. The compositions of the present invention are typically applied to the locus of the unwanted plant(s) by spraying the liquid (sprayable) compositions with spray equipment such as knapsack sprayer, hose end applicators or RTU pump sprayers.

Treatment of the (areas of) undesired plant growth may typically be performed by operators, greenkeepers, gardeners or home owners.

The compositions of the present invention can be used for controlling various kinds of weeds developing in the areas mentioned above.

The compositions of the present invention have an excellent herbicidal activity against a broad range of important monocotyledonous and dicotyledonous harmful plants in the field of environmental health. The compositions of the present invention also act efficiently on perennial weeds which produce shoots from rhizomes, root stocks or other perennial organs and which are difficult to control.

The compositions of the present invention show excellent controlling effect against a wide range of weeds such as annual or perennial gramineae, said gramineae typically belong to one or more of the genera Agropyron, Agrostis, Axonopus, Bromus, Buchloe, Cynodon, Eremochloa, Festuca, Lolium, Paspalum, Pennisetum, Phleum, Poa, Stenotaphrum or Zoysia.

Examples of the unwanted plant (weed) species to be controlled are the following:

Monocotyledonous weeds such as: Digitaria ciliayis (Retz.) Koeler, Eleusine indica (L.) Gaertn., Digitaria sanguinalis (L.) Scop. Setaria viridis (L.) Beauv. var. viridis, Poa annua L., Alopecurus aequalis Sobol. var. amurensis, Imperata cylindrica (L.) Beau., Luzula capitata (Mig.) Mig, Cyperus rotundus L., Cyperus brevifolius (Rottb.) Hassk. var. leiolepis, Digitaria radicosa (Presl) Mig., Digitaria violascens Link), Setaria faberii Herrm, Holcus lanatus, etc.

Dicotyledonous weeds such as: Rumex japonicus Houtt., Portulaca oleracea L. var. oleracea, Stellaria neglecta Weihe, Kummerowia striata (Thunb. ex Murray) Schindl., Euphorbia supina Rafin, Galinsoga ciliata (Rafin.) Blake, Cerastium glomeratum Thuill., Stellaria alsine Grimm. var. undulata (Thunb. ex Murray) Ohwi, Cardamine flexuosa With., Capsella bursa-pastoris Medicus, Lamium amplexicaule L., Veronica persica Poir., Veronica filiformis, Aster maaekii Regel, Oxalis corniculata L., Hydrocotyle sibthorpioides Lam., Plantago asiatica L., Plantago lanceolata L., Plantago media, Plantago major, Artemisia indica Willd. var. maximowiczii (Nakai) Hara, Erigeron philadelphicus L., Rumex acetosa L., Taraxacum officinale Weber, Bellis perennis, Achilea millefolia, Crepis capillaris, Prunella vulgaris, Ranunculus repens, Ranunculus acris, Trifolium repens, Trifolium dubium, Potentilla spp. etc.

Examples of weed species that are controlled by the compositions of the present invention are in particular BLATA (Calyptocarpus vialis, sprawling horseweed), BOTIS (Bothriochloa ischaemum var. songarica), CYNDA (Cynodon dactylon, bermudagrass), DIGSA (Digitaria sanguinalis, large crabgrass), FESAR (Schedonorus arundinaceus, Festuca elatior var. arundinacea, Lolium arundinaceum, tall fescue), FRAVI (Fragaria virginiana, wild strawberry), LESST (Kummerowia striata, common lespedeza), OXACO (Oxalis corniculata, creeping woodsorrel), PASNO (Paspalum notatum, bahiagrass), PLALA (Plantago lanceolata, buckhorn plantain), POAPR (Poa pratensis, Kentucky bluegrass), POROL (Portulaca oleracea, common purslane), PYLUR (Phyllanthus urinaria, chamber bitter), RUMCR (Rumex crispus, curly dock), SETVI (Setaria viridis, green foxtail), STPSE (Stenotaphrum secundatum, St. Augustinegrass), TAROF (Taraxacum officinale, dandelion), TOXRA (Toxicodendron radicans, poison ivy), TRFPR (Trifolium pratense), TRFRE (Trifolium repens, white clover), and URTUR (Urtica urens, burning nettle).

The use of the compositions of the present invention, however, should not be restricted to these weeds in any way, but can be applied against other weeds in the same manner.

If the herbicidal compositions according to the present invention are applied to the soil surface before germination, i.e. pre-emergence of the unwanted plants (weeds), then the unwanted plant seedlings are either prevented completely from emerging or the unwanted plants grow until they have reached the cotyledon stage, but then their growth stops and they finally die completely after three to four weeks have elapsed.

When the herbicidal compositions according to the present invention are applied post-emergence to the green parts (in particular the foliage) of the plants, growth stops over time after treatment and the weed plants remain at the stage of growth at the time of application, or they die completely after a certain time, thereby the weed plants are eliminated at an early stage and in a sustained manner.

It is also possible to use the compositions of the present invention in combination (e.g. sequentially) with other pesticidally active substances or nutritients, such as, for example, insecticides, acaricides, fungicides, fertilizers and/or growth regulators.

In a further aspect, the present invention relates to a method for controlling weed plants in useful plants, characterized in that a herbicidal composition according to the present invention is applied to the weed plants, plants, plant seeds, or to the area on which the weed plants are growing or will be growing.

In a further aspect, the present invention relates to the use of a herbicidal composition according to the present invention for controlling unwanted plants, optionally unwanted plants growing in areas of useful plants.

The present invention thus also provides for the use of the herbicidal compositions of the invention for controlling unwanted plant growth, i.e. for killing of unwanted plants or for controlling the growth and proliferation of unwanted plants.

When the herbicidal compositions of the invention are used, a very broad spectrum of weed plants are controlled pre-emergence and post-emergence, examples being annual and perennial monocotyledonous or dicotyledonous weeds, and also unwanted crop plants.

The method or use according to the present invention can be carried out pre-emergence, early post-emergence or post-emergence of the unwanted plants (weeds).

The present invention accordingly further provides a method for controlling unwanted plants that is characterized in that components (A), (B) and (C), and optionally (D), of the herbicidal compositions of the invention are applied to the plants (e.g. weed plants such as monocotyledonous or dicotyledonous weeds or unwanted crop plants) or to the area on which the plants are growing or can be expected to be growing.

The compositions of the present invention can be applied in many areas, sites and locations, such as for example hardscapes, patios, walkways, driveways, gravel areas, mulch beds, in landscape beds, around vegetable gardens, in or around flower beds, in or around landscape(d) areas, around perennial landscape plants, flower gardens, ornamental gardens, around trees and shrubs (e.g. plantations and orchards), along fences and foundations, edging around foundations, buildings or retaining walls, wooded or vacant lots, recreational areas, fields, trails, parks, sports facilities, xeriscapes, desert landscapes, rockgardens, around homes, buildings, cabins, lodges or camp sites, vines growing up poles, mature trees, trunks or freshly cut woody stumps.

In a further aspect, the present invention relates to methods and uses as defined in the context of the present invention, wherein a herbicidal composition according to the present invention is applied to unwanted plants in the field of environmental health, typically hardscapes or landscapes roadsides, driveways, patios, sidewalks, gravel areas, parks, public gardens, private gardens, plantations, orchards, sports grounds, arenas, mulch beds, in or around flower beds, in or around landscape(d) areas, around perennial landscape plants, around trees and shrubs (e.g. plantations and orchards), along fences and foundations, edging around foundations, buildings or retaining walls, wooded or vacant lots, recreational areas, fields, trails, parks, sports facilities, xeriscapes, desert landscapes, rockgardens, around homes, buildings, cabins, lodges or camp sites, vines growing up poles, mature trees, trunks or freshly cut woody stumps.

By unwanted plants are meant all plants that are growing at locations where they are unwanted. These may be, for example, weed plants (e.g. monocotyledonous or dicotyledonous weeds or unwanted crop plants).

Typically, in case a composition of the present invention is in the form of a concentrate, 6 liquid ounces (177.441 mL) of concentrate per gallon (3.78541 Liters) of water are used and applying the resulting mixture to 300 square feet (27.8709 m²). In case a composition of the present invention is in the form of a ready-to-use (RTU) composition, said RTU composition is typically applied neat (i.e. without further dilution with water) at a rate of one gallon (3.78541 Liters) per 300 square feet (27.8709 m²).

The application or use rates of the herbicidal active ingredients present in compositions of the present invention typically are
for Component (A) from about 1000 to about 2000 g/ha,
for Component (B) from about 1000 to about 2500 g/ha,
and/or
for Component (C): from about 500 to about 1500 g/ha.
If present, the application or use rate for Component (D) is from about 100 to about 1500 g/ha.

The application or use rates of the herbicidal active ingredients present in compositions of the present invention may also typically be the following:
Component (A): from about 1200 to about 1500 g/ha, typically from about 1300 to about 1400 g/ha,
Component (B): from about 1500 to about 1800 g/ha, typically from about 1600 to about 1700 g/ha,
Component (C): from about 900 to about 1100 g/ha, typically from about 950 to about 1050 g/ha,
Component (D), if present: from about 150 to about 1200 g/ha, typically from about 200 g/ha or about 1060 g/ha.

According to the methods or uses according to the present invention the components (A), (B) and (C), and optionally (D), are applied together as a single composition, i.e. a premix composition.

If the compositions of the present invention are in the form of a concentrate, said concentrate are typically diluted with an appropriate amount of water before being applied pre-emergence to the area where weed plants will be growing of to the foliage of the weed plants if applied post-emergence of the weed plants.

In a further aspect the present invention provides for a method of manufacturing a composition of the present invention, wherein Component (A) is mixed with Component (B) and Component (C), optionally with Component (D), typically in this order, and further constituents present in the composition.

The compositions or formulations suitable to be used in the context of the present invention contain generally a total amount in the range of from about 0.1 to about 15% per cent by weight of components (A), (B) and (C), and if present component (D), typically in the range of from about 0.2 to about 10% by weight, in each case based on the total weight of the composition or formulation.

The herbicidal compositions of the invention can be produced by other known methods, for example as mixing of the individual components with adjuvants and/or customary formulation assistants to form premix combinations. These premix combinations being then employed in a customary way, for example as dilutions with water. They may also be produced in the form of what are called tank mixes, by joint dilution of the separately formulated or partially separately formulated individual components with water.

The components (A), (B) and (C), and optionally (D), can be converted together or separately into application formulations, for example for application by spraying, watering and sprinkling, such as solutions, emulsions, suspensions, powders, foams, pastes, granules, and other forms known in the art. The formulations may comprise the customary auxiliaries and adjuvants such as those mentioned above.

These formulations are produced in a known manner, for example by mixing the components (A), (B) and (C), and optionally (D), with customary auxiliaries and adjuvants, typically those mentioned above.

The herbicidal compositions or formulations according to the present invention comprising components (A), (B) and (C), and if present component (D), can also be used as a mixture with other agrochemically active ingredients for controlling unwanted plant growth, for example for controlling weeds.

Also possible are mixtures with other known active ingredients such as fungicides, insecticides, acaricides, nematicides, bird antifeedants, plant nutrients and soil improvers, and likewise with (other) adjuvants and (other) formulation assistants customary in agrochemical formulation.

The herbicidal compositions or formulations according to the present invention comprising components (A), (B) and (C), and if present component (D), can be used in the form of their formulations or the use forms prepared therefrom by further dilution, such as ready-to-use solutions, suspensions, emulsions, powders, pastes and granules. Application is typically accomplished, for example, by watering, sprinkling, spraying, broadcasting.

The herbicidal compositions or formulations according to the present invention comprising components (A), (B) and (C), and if present component (D), can be deployed on the plants, plant parts, typically on the green plants and plant parts. One means of the deployment of premix combination, optionally diluted with water in a tank mix. Another means of application is application is the co-deployment of the active ingredients in the form of tank mixes, by mixing the optimally formulated concentrated formulations of the individual active ingredients together in the tank with water and deploying the spray liquor obtained.

### EXAMPLES

Unless indicated otherwise, all amounts and percentages are by weight.

The materials used and meanings of the abbreviations are as follows:
Agnique® CSO-25=Emulsifier ethoxylated castor oil, POE 25 (BASF)
Agnique® CSO-30=Emulsifier ethoxylated castor oil, POE 30 (BASF)
DI Water=Deionized water
Makon® DA-6=Surfactant isodecyl alcohol ethoxylate, POE-6 (CAS Reg. No. 61827-42-7) (Stepan)
PEG 400=Polyethylene glycol 400
Proxel® GXL=Biocide solution of 20% of 1,2-benzisothiazolin-3-one containing in aqueous dipropylene glycol (Lonza)
SAG 10=Silicone-based antifoam emulsion (Momentive performance materials), 10% actives content
SAG 1572=Polydimethylsiloxane-based antifoam emulsion (Momentive performance materials), 15-20% actives content
Triclopyr TEA=Triclopyr triethylamine salt
Toximul® 8320=Surfactant butyl polyalkylene oxide block copolymer (CAS Reg. No. 9038-95-3) (Stepan)
Conc.=Concentrate
DAT=Days after treatment
HAT=Hours after treatment
oz=US fluid ounce (29.5735 mL)
RTU=Ready-to-use
UTC=Untreated control
wt. %=Constituent weight percentage relative to the respective composition
Ortho® Groundclear Veg Killer=Commercial product containing 5% ammonium nonanoate
Roundup® L&G RTU=Commercial product containing 2% glyphosate and 2% pelargonic acid
Spectracide™ RTU=Commercial product Spectracide™ Weed & Grass Killer2 (Ready-To-Use) containing 0.12% diquat dibromide, 0.06% fluazifop-p-butyl, and 0.04% dicamba dimethylamine salt
Roundup® W&G Kill Super Conc.=Commercial product Roundup® Weed & Grass Killer Super Concentrate containing 50.2% glyphosate isopropylamine salt
Ortho® Groundclear Super Conc.=Commercial product Ortho® Groundclear Weed & Grass Killer Super Concentrate containing 2.53% diquat dibromide, 0.84% fluazifop-P-butyl, and 0.67% dicamba, dimethylamine salt
Ortho® Groundclear W&G Killer RTU=Commercial product Ortho® Groundclear Weed & Grass Killer Ready-To-Use containing 5% ammonium nonanoate
Ortho® Groundclear Year Long Vegetation Killer=Commercial product Ortho® Groundclear Year Long Vegetation Killer containing 0.09% imazapyr, isopropylamine salt and 2.0% pelargonic acid and related fatty acids
Ortho® Groundclear RTU=Commercial product Ortho® Groundclear Ready-To-Use containing 0.56% glyphosate, isopropylamine salt and 0.09% imazapyr, isopropylamine salt
Spectracide™ Conc.=Commercial product Spectracide™ Weed & Grass Killer Concentrate2 containing 2.3% diquat dibromide, 1.15% fluazifop-P-butyl, and 0.77% dicamba, dimethylamine salt
Spectracide™ Extended Control Concentrate=Commercial product Spectracide™ Weed & Grass Killer With Extended Control Concentrate containing 2.3% diquat dibromide, 1.15% fluazifop-P-butyl, 0.77% dicamba, dimethylamine salt, and 1.92% oxyfluorfen
Spectracide™ Extended Control RTU=Commercial product Spectracide™ Weed & Grass Killer With Extended Control (Ready-To-Use) containing 0.12% diquat dibromide, 0.06% fluazifop-P-butyl, 0.04% dicamba, dimethylamine salt, and 0.1% oxyfluorfen
DIGSA=Digitaria sanguinalis
FESAR=Schedonorus arundinaceus
LESST 32 Kummerowia striata
POROL=Portulaca oleracea
STPSE=Stenotaphrum secundatum
TAROF=Taraxacum officinale
TRFRE=Trifolium repens

### Method of Preparation of the Compositions Shown in Tables 1 to 4:

In a vessel equipped with a mixer, the non-ionic surfactants (Agnique® CSO-25 and Agnique® CSO-30 or Makon® DA-6 and Toximul® 8320), and the PEG400 or the Propylene glycol were charged and the mixer started,
Fluazifop P-Butyl technical grade was added and mixed for at least 10 minutes until fully dissolved,
DI water was added with continued mixing.
With continued mixing the other herbicidal active ingredients were added in the order:
Triclopyr TEA solution (44.4% in water),
Diquat Dibromide (37.3% in water),
Imazapic ammonium (23.6% in water), if present,
Biocide (Proxel® GXL) was added, followed by
Antifoam (SAG 10 or SAG 1572), and
Citric acid (pure or 50% solution in water) as needed to adjust the pH, and mixing continued until homogenous.

### Compositions of the Present Invention:

Compositions of the present invention in the form of concentrates are shown in Tables 1 and 3. Compositions of the present invention in the form of ready-to-use (RTU) compositions are shown in Tables 2 and 4.

TABLE 1
Concentrate compositions

| | 301766 | 301771 | 301772 |
|---|---|---|---|
| Constituent | (wt. %) | (wt. %) | (wt. %) |
| Fluazifop P-butyl | 2.00% | 2.00% | 2.00% |
| Triclopyr TEA | 2.50% | 2.50% | 2.50% |
| Diquat dibromide | 1.50% | 1.50% | 1.50% |
| Imazapic ammonium | 0.00% | 0.30% | 1.60% |
| Makon ® DA-6 | 5.00% | 5.00% | 5.00% |
| Toximul ® 8320 | 5.00% | 5.00% | 5.00% |
| SAG 10 | 0.01% | 0.01% | 0.01% |
| Citric Acid liquid | 0.16% | 0.16% | 0.16% |
| (50% in water) | | | |
| Propylene glycol | 10.00% | 10.00% | 10.00% |
| DI Water | 73.83% | 73.53% | 72.23% |
| pH-value | 5.5 | 5.5 | 5.5 |

TABLE 2
Ready-to-use compositions

| | 301751 | 301754 | 301755 |
|---|---|---|---|
| Constituent | (wt. %) | (wt. %) | (wt. %) |
| Fluazifop P-butyl | 0.10% | 0.10% | 0.10% |
| Triclopyr TEA | 0.125% | 0.125% | 0.125% |
| Diquat dibromide | 0.075% | 0.075% | 0.075% |
| Imazapic ammonium | 0.00% | 0.08% | 0.17% |
| Makon ® DA-6 | 0.25% | 0.25% | 0.25% |
| Toximul ® 8320 | 0.25% | 0.25% | 0.25% |
| SAG 10 | 0.01% | 0.01% | 0.01% |
| Proxel ® GXL | 0.10% | 0.10% | 0.10% |
| DI Water | 99.09% | 99.01% | 98.92% |

TABLE 3
Concentrate compositions

| | 301915 | 301914 | 301907 |
|---|---|---|---|
| Constituent | (wt. %) | (wt. %) | (wt. %) |
| Fluazifop P-butyl | 2.00% | 2.00% | 2.00% |
| Triclopyr TEA | 2.50% | 2.50% | 2.50% |
| Diquat dibromide | 1.50% | 1.50% | 1.50% |
| Imazapic ammonium | 0.0% | 0.30% | 1.60% |
| Agnique ® CSO-25 | 7.00% | 7.00% | 7.00% |
| Agnique ® CSO -30 | 7.00% | 7.00% | 7.00% |
| PEG 400 | 5.00% | 5.00% | 5.00% |
| Citric Acid | 0.01% | 0.01% | 0.01% |
| Proxel ® GXL | 0.10% | 0.10% | 0.10% |
| SAG 1572 | 0.01% | 0.01% | 0.01% |
| DI Water | 74.88% | 74.58% | 73.28% |
| pH-value | 6.7 | 6.8 | 6.7 |

TABLE 4
Ready-to-use compositions

| | 301940 | 301939 | 301924 |
|---|---|---|---|
| Constituent | (wt. %) | (wt. %) | (wt. %) |
| Fluazifop P-butyl | 0.10% | 0.10% | 0.10% |
| Triclopyr TEA | 0.122% | 0.122% | 0.122% |
| Diquat dibromide | 0.072% | 0.072% | 0.072% |
| Imazapic ammonium | 0.0% | 0.015% | 0.078% |
| Agnique ® CSO-25 | 0.34% | 0.34% | 0.34% |
| Agnique ® CSO -30 | 0.34% | 0.34% | 0.34% |
| PEG 400 | 0.24% | 0.24% | 0.24% |
| Citric Acid | 0.01% | 0.01% | 0.01% |
| Proxel ® GXL | 0.10% | 0.10% | 0.10% |
| SAG 1572 | 0.01% | 0.01% | 0.01% |
| DI Water | 98.666% | 98.651% | 98.588% |
| pH-value | 6.8 | 6.8 | 6.9 |

### Example G: Post-Emergence Weed Control Data—Greenhouse Trials

Seeds of the respective weed plants were sown in 3.5 inches (8.89 cm) pots containing a 50:50 mix of Redi-earth (Sun Gro, Bellevue, Washington) and soil at 0.5 to 0.75 inches (1.27 to 1.905 cm) deep. The compositions of the present invention and commercially available products were then applied each to the different weed species post-emergence under the same conditions using a laboratory track sprayer calibrated to deliver 15 gallons per acre (140.31 L/ha). Following the application, the pots were placed in a greenhouse and overhead irrigated with 0.25 inches (0.635 cm) for activation and maintained under good growth conditions for the weed plants. Visual scoring of the damage to the weed plants took place after a respective trial time indicated in the following Tables in comparison to untreated controls (herbicidal activity in per cent (%): 100% activity=plants have died; 0% activity=as control plants). The results are set out in the Tables G1 to G5 below. Weed species that were evaluated were Digitaria sanguinalis (DIGSA), Schedonorus arundinaceus (FESAR), Trifolium repens (TRFRE), Portulaca oleracea (POROL),

TABLE G1
Greenhouse trial results using different
compositions/products - control at 15 DAT
Weed control in % (15 DAT)

| Composition/Product | DIGSA | FESAR | POROL | TRFRE |
|---|---|---|---|---|
| Spectracide RTU | 80 | 58 | 85 | 70 |
| Ortho Groundclear Veg | 90 | 83 | 81 | 80 |
| Killer | | | | |
| Roundup L&G RTU | 98 | 89 | 87 | 66 |
| 301940 from Table 4 (RTU) | 81 | 59 | 100 | 79 |
| 301939 from Table 4 (RTU) | 70 | 75 | 99 | 78 |
| 301924 from Table 4 (RTU) | 83 | 83 | 100 | 81 |
| UTC | 0.00 | 0.00 | 0.00 | 0.00 |

TABLE G2
Greenhouse trial results using different compositions/products - control of DIGSA
DIGSA - Control in %

| | Composition | | | | | |
|---|---|---|---|---|---|---|
| Product | 1 HAT | 3 HAT | 3 DAT | 7 DAT | 14 DAT | 21 DAT |
| Spectracide RTU | 3.75 | 8.75 | 72.50 | 82.50 | 82.50 | 70.00 |
| Spectracide conc 7 oz/gallon | 0.00 | 0.00 | 62.50 | 52.50 | 36.25 | 17.50 |
| Ortho Super Conc. | 0.00 | 5.00 | 60.00 | 55.00 | 38.75 | 22.50 |
| 301751 from Table 2 (RTU) | 5.00 | 13.75 | 90.00 | 100.00 | 100.00 | 95.00 |
| 301754 from Table 2 (RTU) | 3.75 | 12.50 | 86.25 | 92.50 | 92.50 | 95.00 |
| 301940 from Table 4 (RTU) | 6.00 | 12.50 | 77.50 | 81.25 | 82.50 | 76.25 |
| 301939 from Table 4 (RTU) | 5.00 | 10.00 | 72.50 | 80.00 | 71.25 | 55.00 |
| 301924 from Table 4 (RTU) | 3.50 | 11.25 | 72.50 | 80.00 | 83.75 | 82.50 |
| 301766 from Table 1 (Conc.) | 4.00 | 10.00 | 82.50 | 93.75 | 91.25 | 88.75 |
| 301915 from Table 3 (Conc.) | 4.00 | 7.50 | 75.00 | 81.25 | 76.25 | 66.25 |
| 301914 from Table 3 (Conc.) | 6.00 | 9.25 | 75.00 | 77.50 | 77.50 | 61.25 |
| 301907 from Table 3 (Conc.) | 6.25 | 11.25 | 75.00 | 81.25 | 83.75 | 81.25 |
| Ortho Ground Clear | 21.25 | 45.00 | 85.00 | 88.75 | 90.00 | 87.50 |
| Spectracide 7 oz/gallon | 3.75 | 12.50 | 77.50 | 87.50 | 83.75 | 71.25 |
| Roundup L&G RTU | 21.25 | 57.50 | 87.50 | 90.00 | 97.50 | 97.50 |
| Roundup Super Concentrate 2.5 | 0.00 | 0.00 | 42.50 | 96.25 | 100.00 | 100.00 |
| oz/gallon | | | | | | |
| UTC | 0.00 | 0.00 | 0.00 | 0.00 | 0.00 | 0.00 |

TABLE G3
Greenhouse trial results using different compositions/products - control of FESAR
FESAR - Control in %

| | Composition | | | | | |
|---|---|---|---|---|---|---|
| Product | 1 HAT | 3 HAT | 3 DAT | 7 DAT | 14 DAT | 21 DAT |
| Spectracide RTU | 0.00 | 2.50 | 42.50 | 61.25 | 57.50 | 47.50 |
| Spectracide conc 7 oz/gallon | 0.00 | 0.00 | 10.00 | 2.50 | 0.00 | 0.00 |
| Ortho Super Conc. | 0.00 | 2.50 | 20.00 | 15.00 | 10.00 | 5.00 |
| 301751 from Table 2 (RTU) | 3.75 | 6.25 | 51.25 | 67.50 | 77.50 | 70.00 |
| 301754 from Table 2 (RTU) | 0.00 | 3.75 | 42.50 | 65.00 | 80.00 | 86.25 |
| 301940 from Table 4 (RTU) | 0.00 | 1.25 | 48.75 | 57.50 | 60.00 | 53.75 |
| 301939 from Table 4 (RTU) | 1.25 | 2.50 | 55.00 | 67.50 | 76.25 | 71.25 |
| 301924 from Table 4 (RTU) | 0.00 | 0.00 | 52.50 | 72.50 | 85.00 | 83.75 |
| 301766 from Table 1 (Conc.) | 1.25 | 5.00 | 56.25 | 63.75 | 62.50 | 57.50 |
| 301915 from Table 3 (Conc.) | 0.00 | 0.00 | 42.50 | 55.00 | 50.00 | 40.00 |
| 301914 from Table 3 (Conc.) | 0.00 | 3.75 | 57.50 | 71.25 | 78.75 | 68.75 |
| 301907 from Table 3 (Conc.) | 0.00 | 0.00 | 58.75 | 75.00 | 88.75 | 93.75 |
| Ortho Ground Clear | 0.00 | 2.50 | 40.00 | 56.25 | 82.50 | 96.25 |
| Spectracide 7 oz/gallon | 0.00 | 1.25 | 51.25 | 67.50 | 65.00 | 50.00 |
| Roundup L&G RTU | 0.00 | 0.00 | 30.00 | 58.75 | 87.50 | 87.50 |
| Roundup Super Concentrate 2.5 | 0.00 | 0.00 | 17.50 | 55.00 | 88.75 | 88.75 |
| oz/gallon | | | | | | |
| UTC | 0.00 | 0.00 | 0.00 | 0.00 | 0.00 | 0.00 |

TABLE G4
Greenhouse trial results using different compositions/products - control of POROL
POROL - Control in %

| | Composition | | | | | |
|---|---|---|---|---|---|---|
| Product | 1 HAT | 3 HAT | 3 DAT | 7 DAT | 14 DAT | 21 DAT |
| Spectracide RTU | 3.75 | 13.75 | 80.00 | 95.00 | 91.25 | 90.00 |
| Spectracide conc 7 oz/gallon | 0.00 | 0.00 | 25.00 | 35.00 | 30.00 | 25.00 |
| Ortho Super Conc. | 2.50 | 5.00 | 51.25 | 58.75 | 50.00 | 52.50 |
| 301751 from Table 2 (RTU) | 5.00 | 12.50 | 87.50 | 100.00 | 100.00 | 100.00 |
| 301754 from Table 2 (RTU) | 6.25 | 11.25 | 77.50 | 97.50 | 100.00 | 100.00 |
| 301940 from Table 4 (RTU) | 7.50 | 20.00 | 85.00 | 100.00 | 100.00 | 100.00 |
| 301939 from Table 4 (RTU) | 1.25 | 15.00 | 82.50 | 95.00 | 100.00 | 100.00 |
| 301924 from Table 4 (RTU) | 6.25 | 17.50 | 86.25 | 100.00 | 100.00 | 100.00 |
| 301766 from Table 1 (Conc.) | 7.50 | 15.00 | 82.50 | 95.00 | 92.50 | 90.00 |
| 301915 from Table 3 (Conc.) | 2.50 | 16.25 | 87.50 | 100.00 | 100.00 | 100.00 |
| 301914 from Table 3 (Conc.) | 6.25 | 17.50 | 85.00 | 100.00 | 100.00 | 100.00 |
| 301907 from Table 3 (Conc.) | 7.50 | 20.00 | 88.75 | 100.00 | 100.00 | 100.00 |
| Ortho Ground Clear | 21.25 | 42.50 | 65.00 | 75.00 | 80.00 | 87.50 |
| Spectracide 7 oz/gallon | 5.00 | 17.50 | 78.75 | 90.00 | 85.00 | 81.25 |
| Roundup L&G RTU | 23.75 | 37.50 | 67.50 | 95.00 | 95.00 | 100.00 |
| Roundup Super Concentrate 2.5 | 1.25 | 1.25 | 23.75 | 95.00 | 100.00 | 100.00 |
| oz/gallon | | | | | | |
| UTC | 0.00 | 0.00 | 0.00 | 0.00 | 0.00 | 0.00 |

TABLE G5
Greenhouse trial results using different compositions/products - control of TRFRE
TRFRE - Control in %

| | Composition | | | | | |
|---|---|---|---|---|---|---|
| Product | 1 HAT | 3 HAT | 3 DAT | 7 DAT | 14 DAT | 21 DAT |
| Spectracide RTU | 8.75 | 18.75 | 75.00 | 81.25 | 76.25 | 66.25 |
| Spectracide conc 7 oz/gallon | 0.00 | 0.00 | 17.50 | 16.25 | 11.25 | 2.50 |
| Ortho Super Conc. | 2.50 | 7.50 | 42.50 | 38.75 | 28.75 | 17.50 |
| 301751 from Table 2 (RTU) | 8.75 | 13.75 | 77.50 | 82.50 | 81.25 | 78.75 |
| 301754 from Table 2 (RTU) | 7.50 | 15.00 | 70.00 | 82.50 | 82.50 | 81.25 |
| 301940 from Table 4 (RTU) | 8.75 | 17.50 | 73.75 | 82.50 | 85.00 | 77.50 |
| 301939 from Table 4 (RTU) | 5.00 | 12.50 | 71.25 | 81.25 | 82.50 | 76.25 |
| 301924 from Table 4 (RTU) | 5.00 | 12.50 | 70.00 | 81.25 | 85.00 | 86.25 |
| 301766 from Table 1 (Conc.) | 5.00 | 15.00 | 68.75 | 80.00 | 78.75 | 67.50 |
| 301915 from Table 3 (Conc.) | 5.00 | 16.25 | 70.00 | 82.50 | 82.50 | 70.00 |
| 301914 from Table 3 (Conc.) | 5.00 | 18.75 | 67.50 | 82.50 | 87.50 | 80.00 |
| 301907 from Table 3 (Conc.) | 6.25 | 16.25 | 75.00 | 82.50 | 83.75 | 85.00 |
| Ortho Ground Clear | 25.00 | 50.00 | 65.00 | 82.50 | 82.50 | 83.75 |
| Spectracide 7 oz/gallon | 5.00 | 16.25 | 76.25 | 87.50 | 85.00 | 76.25 |
| Roundup L&G RTU | 26.25 | 45.00 | 66.25 | 72.50 | 67.50 | 67.50 |
| Roundup Super Concentrate 2.5 | 0.00 | 0.00 | 25.00 | 55.00 | 60.00 | 66.25 |
| oz/gallon | | | | | | |
| UTC | 0.00 | 0.00 | 0.00 | 0.00 | 0.00 | 0.00 |

### Example F: Post-Emergence Weed Control Data—Field Trials

U.S. field trials were conducted in the summer of 2020 in several different states to assess the weed control efficacy and the potential for the compositions of the present invention shown in Tables 1 to 4 for providing rapid burndown as well as final weed control activity. To assess the rapid burndown, visual evaluations recorded as % injury were made at 3 and 6 hours after treatment (HAT). To assess systemic final control of the respective weed, visual evaluations recorded as % control were conducted at 15 and 30 days after treatment (DAT). Additionally, for the imazapic containing compositions, residual weed control values recorded as % weed free were made at monthly intervals, through either 4 or 9 to 12 months as indicated in the tables hereinafter. The selected field trial sites contained existing weed populations. Weeds were in actively growing condition, the weed heights ranging from about 3 inches (7.62 cm) to about 6 inches (15.24 cm). Applications were made to small plots (15 square feet, 1.39355 m²), 3 replications per treatment and arranged in a randomized complete block design for each location.

For the above-mentioned concentrate compositions shown in Tables 1 and 3, spray solutions were made by mixing 6 oz (about 177.441 mL) of the respective concentrate composition per gallon (about 3.78541 Liters) of water to give a spray solution, and that spray solution was then applied to 300 square feet (about 27.8709 m²) of area to be treated (this is equivalent to 145.2 gallons (about 549.64169 Liters) per acre (about 0.404686 hectare (ha)). For the above mentioned ready-to-use (RTU) compositions shown in Tables 2 and 4, no mixing with water was required and these compositions were applied as such, i.e. without dilution with water, also at a rate of 1 gallon (about 3.78541 Liters) per 300 square feet (about 27.8709 m²). The corresponding application rates of the respective herbicidal active ingredients present as the components (A), (B), (C), and optionally (D), of compositions of the present invention are shown in Table R.

TABLE R
Application rates of the herbicidal active ingredients
of compositions of the present invention

| | Compo- | Compo- | Compo- | Compo- |
|---|---|---|---|---|
| | nent (A) | nent (B) | nent (C) | nent (D) |
| | g/ha | g/ha | g/ha | g/ha |
| Composition | (lb/acre) | (lb/acre) | (lb/acre) | (lb/acre) |
| 301907 from | 1328.4362 | 1660.5452 | 996.3271 | 1062.7489 |
| Table 3 (Conc.) | (1.1852) | (1.4815) | (0.8889) | (0.9482) |
| 301914 from | 1328.4362 | 1660.5452 | 996.3271 | 199.2654 |
| Table 3 (Conc.) | (1.1852) | (1.4815) | (0.8889) | (0.1778) |
| 301915 from | 1328.4362 | 1660.5452 | 996.3271 | 0.0000 |
| Table 3 (Conc.) | (1.1852) | (1.4815) | (0.8889) | (0.0000) |
| 301924 from | 1317.4433 | 1656.9906 | 991.4780 | 1059.3874 |
| Table 4 (RTU) | (1.1754) | (1.4783) | (0.8846) | (0.9452) |
| 301939 from | 1317.4433 | 1656.9906 | 991.4780 | 203.7283 |
| Table 4 (RTU) | (1.1754) | (1.4783) | (0.8846) | (0.1818) |
| 301940 from | 1317.4433 | 1656.9906 | 991.4780 | 0.0000 |
| Table 4 (RTU) | (1.1754) | (1.4783) | (0.8846) | (0.0000) |

For comparison, several commercial products were also assessed in the same manner under the same conditions in the same locations having the same weed population. The Ortho Groundclear Super Conc. was mixed at 10 oz (about 295.735 mL) per gallon (about 3.78541 Liters) of water to give a spray solution and application thereof to 350 square feet (about 32.5161 m²), and the Spectracide Conc. was mixed at 7 oz (about 207.015 mL) per gallon (about 3.78541 Liters) of water to give a spray solution and application thereof to 300 square feet (about 27.8709 m²).

The following Tables F1 to F10 show the field trial results for the different compositions or products used recorded as % injury or as % control of the respective weed species. Visual evaluations were recorded as % injury at 3 and 6 hours after treatment (HAT) and as % control at 15 and 30 days after treatment (DAT), respectively.

TABLE F1
Field trial results using different compositions/products - DIGSA

| | % injury, | % injury, | % control, | % control, |
|---|---|---|---|---|
| | average | average | average | average |
| Composition/Product | 3 HAT | 6 HAT | 15 DAT | 30 DAT |
| 301940 from Table 4 | 44.4 | 56.1 | 92.5 | 90.4 |
| (RTU) | | | | |
| 301915 from Table 3 | 44.2 | 56.7 | 91.25 | 88.8 |
| (Conc.) | | | | |
| Spectracide Conc. | 55.0 | 59.8 | 92.5 | 90.8 |
| Spectracide RTU | 50.6 | 60.0 | 79.2 | 68.3 |
| Ortho Groundclear | 68.9 | 78.3 | 45.4 | 16.3 |
| W&G Killer RTU | | | | |
| Ortho Groundclear | 48.9 | 62.2 | 92.5 | 89.2 |
| Super Conc. | | | | |
| Roundup W&G Kill | 0.0 | 0.0 | 100.0 | 100.0 |
| Super Conc. | | | | |

TABLE F2
Field trial results using different compositions/products - LESST

| | % injury, | % injury, | % control, | % control, |
|---|---|---|---|---|
| | average | average | average | average |
| Composition/Product | 3 HAT | 6 HAT | 15 DAT | 30 DAT |
| 301940 from Table 4 | 25.6 | 41.8 | 98.2 | 99.2 |
| (RTU) | | | | |
| 301915 from Table 3 | 32.6 | 37.0 | 97.5 | 99.2 |
| (Conc.) | | | | |
| Spectracide Conc. | 32.7 | 45.0 | 100.0 | 100.0 |
| Spectracide RTU | 33.8 | 46.7 | 98.3 | 100 |
| Ortho Groundclear | 57.1 | 76.3 | 80.4 | 70.4 |
| W&G Killer RTU | | | | |
| Ortho Groundclear | 35.5 | 49.6 | 99.1 | 96.4 |
| Super Conc. | | | | |
| Roundup W&G Kill | 0.0 | 0.0 | 100.0 | 100.0 |
| Super Conc. | | | | |

TABLE F3
Field trial results using different compositions/products - STPSE

| | % injury, | % injury, | % control, | % control, |
|---|---|---|---|---|
| | average | average | average | average |
| Composition/Product | 3 HAT | 6 HAT | 15 DAT | 30 DAT |
| 301940 from Table 4 | 28.3 | 40.7 | 90.1 | 88.1 |
| (RTU) | | | | |
| 301915 from Table 3 | 25.9 | 39.5 | 87.4 | 87.3 |
| (Conc.) | | | | |
| Spectracide Conc. | 35.6 | 44.5 | 91.3 | 86.9 |
| Spectracide RTU | 32.9 | 44.5 | 88.7 | 84.3 |
| Ortho Groundclear | 63.0 | 76.8 | 52.6 | 34.5 |
| W&G Killer RTU | | | | |
| Ortho Groundclear | 36.9 | 48.5 | 86.6 | 82.0 |
| Super Conc. | | | | |
| Roundup W&G Kill | 0.0 | 0.0 | 96.7 | 98.7 |
| Super Conc. | | | | |

TABLE F4
Field trial results using different compositions/products - TRFRE

| | % injury, | % injury, | % control, | % control, |
|---|---|---|---|---|
| | average | average | average | average |
| Composition/Product | 3 HAT | 6 HAT | 15 DAT | 30 DAT |
| 301940 from Table 4 | 35.7 | 47.1 | 83.9 | 81.8 |
| (RTU) | | | | |
| 301915 from Table 3 | 39.8 | 54.4 | 79.2 | 77.1 |
| (Conc.) | | | | |
| Spectracide Conc. | 52.5 | 57.5 | 94.0 | 94.3 |
| Spectracide RTU | 45.0 | 55.0 | 94.1 | 97.3 |
| Ortho Groundclear | 67.5 | 78.8 | 53.6 | 43.6 |
| W&G Killer RTU | | | | |
| Ortho Groundclear | 55.0 | 65.6 | 88.2 | 81.4 |
| Super Conc. | | | | |
| Roundup W&G Kill | 0.0 | 0.0 | 97.5 | 99.7 |
| Super Conc. | | | | |

TABLE F5
Field trial results using different compositions/products - FESAR

| | % injury, | % injury, | % control, | % control, |
|---|---|---|---|---|
| | average | average | average | average |
| Composition/Product | 3 HAT | 6 HAT | 15 DAT | 30 DAT |
| 301907 from Table 3 | 15.8 | 53.3 | 97.2 | 100.0 |
| (Conc.) | | | | |
| 301924 from Table 4 | 13.3 | 50.0 | 97.2 | 99.3 |
| (RTU) | | | | |
| Ortho Groundclear | 6.7 | 42.5 | 88.0 | 98.5 |
| Year Long | | | | |
| Vegetation Killer | | | | |
| Ortho Groundclear | 0.0 | 0.8 | 99.2 | 99.7 |
| RTU | | | | |
| Roundup W&G Kill | 0.0 | 0.0 | 100.0 | 100.0 |
| Super Conc. | | | | |

TABLE F6
Field trial results using different compositions/products - DIGSA

| | % injury, | % injury, | % control, | % control, |
|---|---|---|---|---|
| | average | average | average | average |
| Composition/Product | 3 HAT | 6 HAT | 15 DAT | 30 DAT |
| 301907 from Table 3 | 17.5 | 75.5 | 100.0 | 100.0 |
| (Conc.) | | | | |
| 301924 from Table 4 | 17.0 | 72.0 | 100.0 | 100.0 |
| (RTU) | | | | |
| Ortho Groundclear | 8.3 | 70.8 | 100.0 | 100.0 |
| Year Long | | | | |
| Vegetation Killer | | | | |
| Ortho Groundclear | 0.0 | 3.3 | 100.0 | 100.0 |
| RTU | | | | |
| Roundup W&G Kill | 0.0 | 0.0 | 100.0 | 100.0 |
| Super Conc. | | | | |

TABLE F7
Field trial results using different compositions/products - LESST

| | % injury, | % injury, | % control, | % control, |
|---|---|---|---|---|
| | average | average | average | average |
| Composition/Product | 3 HAT | 6 HAT | 15 DAT | 30 DAT |
| 301907 from Table 3 | 8.3 | 45.0 | 86.7 | 96.0 |
| (Conc.) | | | | |
| 301924 from Table 4 | 5.0 | 55.0 | 90.0 | 95.3 |
| (RTU) | | | | |
| Ortho Groundclear | 58.3 | 80.0 | 93.3 | 98.7 |
| Year Long | | | | |
| Vegetation Killer | | | | |
| Ortho Groundclear | 0.0 | 3.3 | 100.0 | 100.0 |
| RTU | | | | |
| Roundup W&G Kill | 0.0 | 0.0 | 100.0 | 100.0 |
| Super Conc. | | | | |

TABLE F8
Field trial results using different compositions/products - DIGSA

| | % injury, | % injury, | % control, | % control, |
|---|---|---|---|---|
| | average | average | average | average |
| Composition/Product | 3 HAT | 6 HAT | 15 DAT | 30 DAT |
| 301914 from Table 3 | 40.6 | 61.1 | 89.3 | 92.5 |
| (Conc.) | | | | |
| 301939 from Table 4 | 36.1 | 60.0 | 93.0 | 92.5 |
| (RTU) | | | | |
| Spectracide Extended | 43.9 | 66.1 | 93.6 | 93.0 |
| Control Concentrate | | | | |
| Spectracide Extended | 46.1 | 65.6 | 88.6 | 92.5 |
| Control RTU | | | | |
| Roundup W&G Kill | 0.0 | 1.1 | 100.0 | 100.0 |
| Super Conc. | | | | |

TABLE F9
Field trial results using different compositions/products - TRFRE

| | % injury, | % injury, | % control, | % control, |
|---|---|---|---|---|
| | average | average | average | average |
| Composition/Product | 3 HAT | 6 HAT | 15 DAT | 30 DAT |
| 301914 from Table 3 | 37.5 | 51.3 | 92.9 | 90.9 |
| (Conc.) | | | | |
| 301939 from Table 4 | 36.3 | 52.2 | 96.1 | 95.3 |
| (RTU) | | | | |
| Spectracide Extended | 53.3 | 65.1 | 98.6 | 98.3 |
| Control Concentrate | | | | |
| Spectracide Extended | 49.6 | 64.6 | 94.5 | 95.2 |
| Control RTU | | | | |
| Roundup W&G Kill | 0.0 | 0.0 | 99.1 | 99.9 |
| Super Conc. | | | | |

TABLE F10
Field trial results using different compositions/products - TAROF

| | % injury, | % injury, | % control, | % control, |
|---|---|---|---|---|
| | average | average | average | average |
| Composition/Product | 3 HAT | 6 HAT | 15 DAT | 30 DAT |
| 301914 from Table 3 | 70.0 | 78.3 | 91.8 | 95.0 |
| (Conc.) | | | | |
| 301939 from Table 4 | 75.0 | 81.6 | 93.0 | 92.8 |
| (RTU) | | | | |
| Spectracide Extended | 73.3 | 81.0 | 98.0 | 88.3 |
| Control Concentrate | | | | |
| Spectracide Extended | 65.0 | 81.6 | 92.2 | 79.3 |
| Control RTU | | | | |
| Roundup W&G Kill | 0.0 | 0.0 | 81.8 | 90.0 |
| Super Conc. | | | | |

The following Tables F11 to F13 show the field trial results for the different compositions or products used. The results were recorded as % weed free area for all weeds present in the respective areas under evaluation in case of Tables F11 and F12, and were recorded at 90, 180, 270 and 365 days after treatment (DAT) in case of Table F11, and after 30, 60, 90 and 120 days after treatment (DAT) in case of Table F12. Table F13 shows the field trial results for the different compositions or products used recorded as % injury or as average % control for all weeds present in the respective areas under evaluation. Visual evaluations were recorded as % injury at 3 and 6 hours after treatment (HAT) and as % control at 15 and 30 days after treatment (DAT), respectively.

The weeds present in the respective areas under evaluation were BLATA (Calyptocarpus vialis, sprawling horseweed), BOTIS (Bothriochloa ischaemum var. songarica), CYNDA (Cynodon dactylon, bermudagrass), DIGSA (Digitaria sanguinalis, large crabgrass), FESAR (Schedonorus arundinaceus, Festuca elatior var. arundinacea, Lolium arundinaceum, tall fescue), FRAVI (Fragaria virginiana, wild strawberry), LESST (Kummerowia striata, common lespedeza), OXACO (Oxalis corniculata, creeping woodsorrel), PASNO (Paspalum notatum, bahiagrass), PLALA (Plantago lanceolata, buckhorn plantain), POAPR (Poa pratensis, Kentucky bluegrass), PYLUR (Phyllanthus urinaria, chamber bitter), RUMCR (Rumex crispus, curly dock), SETVI (Setaria viridis, green foxtail), STPSE (Stenotaphrum secundatum, St. Augustinegrass), TAROF (Taraxacum officinale, dandelion), TRFRE (Trifolium repens, white clover), and URTUR (Urtica urens, burning nettle).

TABLE F11
Field trial results using different
compositions/products - weed free area

| | % weed | % weed | % weed | % weed |
|---|---|---|---|---|
| | free area | free area | free area | free area |
| Composition/Product | 90 DAT | 180 DAT | 270 DAT | 365 DAT |
| 301907 from Table 3 | 95.4 | 92.2 | 89.2 | 31.7 |
| (Conc.) | | | | |
| 301924 from Table 4 | 95.2 | 89.7 | 86.6 | 30.8 |
| (RTU) | | | | |
| Ortho Groundclear | 52.5 | 55.0 | 65.8 | 10.8 |
| Year Long | | | | |
| Vegetation Killer | | | | |
| Ortho Groundclear | 74.2 | 87.7 | 71.7 | 22.5 |
| RTU | | | | |

TABLE F12
Field trial results using different
compositions/products - weed free area

| | % weed | % weed | % weed | % weed |
|---|---|---|---|---|
| | free area | free area | free area | free area |
| Composition/Product | 30 DAT | 60 DAT | 90 DAT | 120 DAT |
| 301914 from Table 3 | 86.6 | 81.1 | 70.2 | 61.2 |
| (Conc.) | | | | |
| 301939 from Table 4 | 89.1 | 83.1 | 73.5 | 65.0 |
| (RTU) | | | | |
| Spectracide Extended | 90.0 | 77.8 | 53.5 | 41.5 |
| Control Concentrate | | | | |
| Spectracide Extended | 84.6 | 70.6 | 50.5 | 36.8 |
| Control RTU | | | | |
| Roundup W&G Kill | 93.9 | 68.1 | 42.6 | 24.9 |
| Super Conc. | | | | |

TABLE F13
Field trial results using different
compositions/products - average injury/control
for all weeds present in the respective
plot under evaluation

| | % injury, | % injury, | % control, | % control, |
|---|---|---|---|---|
| | average | average | average | average |
| Composition/Product | 3 HAT | 6 HAT | 15 DAT | 30 DAT |
| 301940 from Table 4 | 28.3 | 40.7 | 90.1 | 87.3 |
| (RTU) | | | | |
| 301915 from Table 3 | 25.9 | 39.5 | 87.4 | 88.1 |
| (Conc.) | | | | |
| Spectracide Conc. | 35.6 | 44.5 | 91.3 | 86.9 |
| Spectracide RTU | 32.9 | 44.5 | 88.7 | 84.3 |
| Ortho Groundclear | 63.0 | 76.8 | 52.6 | 34.5 |
| W&G Killer RTU | | | | |
| Ortho Groundclear | 36.9 | 48.5 | 86.6 | 82.0 |
| Super Conc. | | | | |
| Roundup W&G Kill | 0.0 | 0.0 | 96.7 | 98.7 |
| Super Conc. | | | | |

Example embodiments have been provided so that this disclosure will be thorough, and will fully convey the scope to those who are skilled in the art. Numerous specific details are set forth such as examples of specific compositions, components, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements. The compositions, components, method steps, processes, and operations described herein are not to be construed as necessarily requiring their performance in the particular order discussed or illustrated, unless specifically identified as an order of performance. It is also to be understood that additional or alternative components, steps, etc. may be employed.

Although the terms first, second, third, etc. may be used herein to describe various elements, components, etc., these elements, components, etc., should not be limited by these terms. These terms may be only used to distinguish one element, component, etc. from another element, component, etc. Terms such as “first,” “second,” and other numerical terms when used herein do not imply a sequence or order unless clearly indicated by the context. Thus, a first element, component, etc. discussed below could be termed a second element, component, etc. without departing from the teachings of the example embodiments.

As various changes could be made in the above compositions and methods without departing from the scope of the present disclosure, it is intended that all matter contained in the above description shall be interpreted as illustrative and not in a limiting sense.

Having described the present disclosure in detail, it will be apparent that modifications and variations are possible without departing from the scope of the present disclosure defined in the appended claims.

What is claimed is:

1. Herbicidal composition comprising herbicidal active ingredients, wherein the herbicidal active ingredients comprise or consist of
(A) fluazifop or an ester thereof,
(B) triclopyr or an ester or an agriculturally acceptable salt thereof,
and
(C) a diquat dihalide salt,
wherein the ratio by weight of the total amount of component (A) to the total amount of component (B) is in the range of from about 2:1 to about 1:4,
and/or
wherein the ratio by weight of the total amount of component (A) to the total amount of component (C) is in the range of from about 2:1 to about 1:3.

2. The herbicidal composition according to claim 1, wherein the herbicidal active ingredients comprise or consist of
(A) fluazifop or an ester thereof,
(B) triclopyr or an ester or an agriculturally acceptable salt thereof,
(C) a diquat dihalide salt,
and
(D) imazapic or an agriculturally acceptable salt thereof.

3. The herbicidal composition according to claim 1, wherein
Component (A) comprises or consists of a fluazifop alkyl ester, preferably fluazifop-P-butyl,
and/or
Component (B) comprises or consists of a triclopyr ammonium salt, preferably triclopyr-triethylammonium.

4. The herbicidal composition according to claim 1, wherein
Component (A) comprises or consists of fluazifop-P-butyl,
Component (B) comprises or consists of triclopyr-triethylammonium,
and
Component (C) comprises or consists of diquat dibromide.

5. The herbicidal composition according to claim 2, wherein component (D) comprises or consists of an imazapic ammonium salt.

6. The herbicidal composition according to claim 4, wherein component (D) comprises or consists of imazapic-ammonium.

7. The herbicidal composition according to claim 1, wherein the ratio by weight of the total amount of component (A) to the total amount of component (B) is in the range of from about 2:1 to about 1:3.

8. The herbicidal composition according to claim 1, wherein the ratio by weight of the total amount of component (A) to the total amount of component (C) is in the range of from about 2:1 to about 1:2.

9. The herbicidal composition according to claim 2, wherein the ratio by weight of the total amount of component (A) to the total amount of component (D) is in the range of from about 10:1 to about 1:2.

10. The herbicidal composition according to claim 1, wherein components (A), (B), (C), and optionally a component (D) are the only herbicidal active ingredients present in the composition, wherein component (D) comprises or consists of an imazapic ammonium salt.

11. The herbicidal composition according to claim 1, wherein the components (A), (B) and (C) are present in the composition in the following amounts:
Component (A) in an amount in the range of from about 0.04 wt. % to about 3.5 wt. %,
Component (B) in an amount in the range of from about 0.05 wt. % to about 4.0 wt. %,
Component (C) in an amount in the range of from about 0.04 wt. % to about 3.0 wt. %,
in each case based on the total weight of the composition.

12. The herbicidal composition according to claim 1, wherein the components (A), (B) and (C) are present in the composition in the following amounts:
Component (A) in an amount in the range of from about 0.05 wt. % to about 3.0 wt. %,
Component (B) in an amount in the range of from about 0.07 wt. % to about 3.5 wt. %,
Component (C) in an amount in the range of from about 0.05 wt. % to about 2.5 wt. %,
in each case based on the total weight of the composition.

13. The herbicidal composition according to claim 2, wherein the component (D) is present in the composition in an amount in the range of from about 0. 0075 wt. % to about 2.5 wt. %, based on the total weight of the composition.

14. The herbicidal composition according to claim 1, wherein the herbicidal composition additionally comprises water and one or more further constituents selected from the group consisting of formulation adjuvants.

15. The herbicidal composition according to claim 1, wherein the herbicidal composition additionally comprises water and one or more further constituents selected from the group consisting of surfactants, emulsifiers, dispersants, organic solvents, anti-freeze agents, pH-regulation agents, biocides and antifoam agents.

16. The herbicidal composition according to claim 1, wherein the herbicidal composition is a composition in the form of a concentrate or a ready-to-use spray application mixture.

17. The herbicidal composition according to claim 1, wherein water is present in the composition in an amount in the range of from about 60 wt. % to about 99.5 wt. %, based on the total weight of the composition.

18. The herbicidal composition according to claim 1, wherein the composition comprises one or more surfactants in an amount in the range of from about 0.15 wt. % to about 25 wt. %, based on the total weight of the composition.

19. The herbicidal composition according to claim 1, wherein the composition is an aqueous herbicidal liquid composition at 25° C. and 1013 mbar.

20. Method for controlling weed plants, characterized in that a herbicidal composition according to claim 1 is applied to the unwanted plants, plant parts or to the area on which the unwanted plants are growing or will be growing.

21. Use of a herbicidal composition according to claim 1 for controlling unwanted plants.

22. Method according to claim 20, wherein a herbicidal composition according to claim 1 is applied to the unwanted plants in the field of environmental health, preferably hardscapes, roadsides, driveways, patios, sidewalks, gravel areas, parks, public gardens, private gardens, plantations, orchards, sports grounds, arenas, mulch beds, in or around flower beds, in vegetable gardens, in or around landscape(d) areas, around perennial landscape plants, around trees and shrubs, plantations, orchards, along fences and foundations, edging around foundations, buildings or retaining walls, wooded or vacant lots, recreational areas, fields, trails, parks, sports facilities, xeriscapes, desert landscapes, rockgardens, around homes, buildings, cabins, lodges or camp sites, vines growing up poles, mature trees, trunks or freshly cut woody stumps.

23. Method according to claim 20, characterized in that it is carried out pre-emergence, early post-emergence or post-emergence of the unwanted plants to be controlled.

24. Method according to claim 20, wherein the composition is used at an application rate such that the amount
of Component (A) is from about 1000 to about 2000 g/ha,
of Component (B) is from about 1000 to about 2500 g/ha,
and/or
of Component (C): is from about 500 to about 1500 g/ha.

25. Method according to claim 20, wherein the composition is used at an application rate such that the amounts of components (A), (B), and (C) are in the range of
from about 1200 g/ha to about 1500 g/ha for Component (A),
from about 1500 g/ha to about 1800 g/ha for Component (B), and
from about 900 g/ha to about 1100 g/ha for Component (C).

26. Method of manufacturing a composition according to claim 1, wherein Component (A) is mixed with Component (B) and Component (C), optionally with a Component (D), preferably in this order, and further constituents present in the composition, wherein Component (D) comprises or consists of an imazapic ammonium salt.
